(19) United States
(12) Patent Application Publication
(10) Pub. No.: US 2018/0060913 A1
(43) Pub. Date: Mar. 1, 2018

(54) INFORMATION PROCESSING APPARATUS, INFORMATION PROCESSING METHOD, AND PROGRAM

(71) Applicant: NEC Personal Computers, Ltd., Tokyo (JP)

(72) Inventor: Takahisa Shirakawa, Tokyo (JP)

(73) Assignee: NEC Personal Computers, Ltd., Tokyo (JP)

(21) Appl. No.: 15/658,841

(22) Filed: Jul. 25, 2017

(30) Foreign Application Priority Data
Aug. 29, 2016 (JP) 2016167362

(51) Int. Cl. G06Q 30/02

(52) U.S. Cl. CPC G06Q 30/0263; G06Q 30/0247

(57) ABSTRACT

The present invention provides an information processing apparatus for selecting an advertisement high in user click-through rate based on the content of the advertisement. The information processing apparatus is characterized by storing an article cluster of articles, identifying the article cluster associated with a specified article, storing advertisement information, composed of each advertisement placed in the articles in the past and profitability information on the advertisements, in association with each of the article clusters, selecting a keyword about the specified article from the advertisements in the identified article cluster and the words in the article to acquire advertisements associated with the selected keyword, and selecting a recommended advertisement from the acquired advertisements based on profitability information on advertisements stored in an article advertisement database for the identified article cluster of the specified article such that the selection probability will be set high when the profitability of each advertisement is high.

### FIELD OF THE INVENTION

The present invention relates to an information processing apparatus, an information processing method, and a program.

### BACKGROUND OF THE INVENTION

A recommendation technique for associating, with each of articles acquired from the Internet and broadcast networks, information related to the article is provided, and there is a technique to apply this recommendation technique to advertisement delivery. As an example of applying the recommendation technique to advertisement delivery, there is recommended advertising. Since this recommended advertising is associated with the article, it is easy to appeal to viewers. Therefore, article posting media can count on the advertisement as a kind of content having an informational value compared with just an ordinary advertisement. Since a commercial product can appeal to users (viewers) who are potentially interested in advertiser's products, this is of advantage to the advertiser.

Since the recommended advertising as mentioned above is associated with an article and selected to be recommended to users, it has a certain effect in having many users recognize a commercial product. However, if a user takes an action (click) on an advertisement, it will become clearer that the advertisement is effective. From such an ideal, an advertisement provided by an advertiser is delivered in association with an article in the advertisement delivery business to make a profit for an advertising agency. For example, the profit often depends on the commissions such as the number (rate) of user clicks on the advertisement, and further the number (rate) of purchased commercial products for which the advertisement is placed. In recent years, the challenge has been how to deliver an advertisement high in user click-through rate in the field of advertisement recommendation technology including recommended advertising.

For example, Patent Document 1 discloses a technique for selecting a keyword from words appearing in each of articles acquired from the Internet and broadcast networks, associating each of advertisements with the selected keyword, and setting, as a keyword evaluated value, a utilization rate of users such as a so-called CTR (click-through rate) on the advertisement to select an advertisement to be placed in the article based on the evaluated value.

[Patent Document 1] Japanese Patent Application Publication No. 2013-020461

It is possible to evaluate an advertisement based on actual user actions by selecting a keyword from words appearing in each of articles and managing advertisements selected using the keyword in units of keywords based on the user actions such as CTR. However, for example, in the technique as disclosed in Patent Document 1, the advertisement evaluated value is calculated using the keyword as a word. Therefore, for example, when “TV” is the keyword, advertisements in completely different categories, such as an “advertisement for a TV set” and an “advertisement for a magazine to advertise a TV program,” are associated with the same keyword. Since these advertisements are different in terms of the purchase frequency and the product price, it cannot be said that the comparison between both using the CTR or the profitability does not result in an appropriate advertisement evaluation. Further, placing an advertisement for a “TV set” in an article suitable for introducing a “magazine for advertising a TV program” such as an article giving an introduction of a new TV program from the standpoint of the profitability of an advertising agency brings the informational value from the perspectives of the viewers and article posting media to naught, and the effect of the advertisement in the article is significantly low in terms of the CTR or the profitability compared with articles suitable for introducing a “TV set” such as articles giving an introduction of 4K broadcasting.

The present invention has been made in view of the above circumstances, and it is an object thereof to provide an information processing apparatus capable of selecting an advertisement determined to be high in user click-through rate appropriately according to the content of the advertisement.

### SUMMARY OF THE INVENTION

An information processing apparatus according to the present invention includes: an article cluster database that stores an article cluster of articles; an article cluster identifying section that identifies the article cluster associated with a specified article based on each of words appearing in the specified article and each of words appearing in the article cluster; an article advertisement database that stores advertisement information, composed of each of advertisements placed in the articles in the past and profitability information indicating an index for measuring how much profit is made from the advertisement, in association with each of the article clusters; an advertisement acquisition section that selects a keyword about the specified article from the advertisements associated with the identified article cluster and the words appearing in the article to acquire advertisements associated with the selected keyword from a network; and an advertisement selection section that selects a recommended advertisement from the advertisements acquired by the advertisement acquisition section based on profitability information on advertisements stored in the article advertisement database for the article cluster of the specified article identified by the article cluster identifying section in such a manner that a selection probability will be set high as the profitability of each of the advertisements is high.

An information processing method according to the present invention including: generating an article cluster database that stores an article cluster of articles; identifying the article cluster associated with a specified article based on each of words appearing in the specified article and each of words appearing in the article cluster; generating an article advertisement database that stores advertisement information, composed of each of advertisements placed in the articles in the past and profitability information indicating an index for measuring how much profit is made from the advertisement, in association with each of the article clusters; selecting a keyword about the specified article from the advertisements associated with the identified article cluster and the words appearing in the article to acquire advertisements associated with the selected keyword from a network; and selecting a recommended advertisement from the acquired advertisements based on profitability information on advertisements stored in the article advertisement database for the identified article cluster of the specified article in such a manner that a selection probability will be set high as the profitability of each of the advertisements is high.

A program causing a computer to execute: generating an article cluster database that stores an article cluster of articles; identifying the article cluster associated with a specified article based on each of words appearing in the specified article and each of words appearing in the article cluster; generating an article advertisement database that stores advertisement information, composed of each of advertisements placed in the articles in the past and profitability information indicating an index for measuring how much profit is made from the advertisement, in association with each of the article clusters; selecting a keyword about the specified article from the advertisements associated with the identified article cluster and the words appearing in the article to acquire advertisements associated with the selected keyword from a network; and selecting a recommended advertisement from the acquired advertisements based on profitability information on advertisements stored in the article advertisement database for the identified article cluster of the specified article in such a manner that a selection probability will be set high as the profitability of each of the advertisements is high.

According to the present invention, an advertisement determined to be high in user click-through rate from the content of the advertisement can be selected appropriately.

### BRIEF DESCRIPTION OF THE DRAWINGS

FIG. 1 is a hardware configuration diagram of an information processing apparatus 1 according to an embodiment of the present invention.

FIG. 2 is a functional block diagram of the information processing apparatus 1 according to the embodiment of the present invention.

FIG. 3 is a table illustrating an example of an article cluster database according to the embodiment of the present invention.

FIG. 4 is a table illustrating an example of an article advertisement database according to the embodiment of the present invention.

FIG. 5 is a diagram illustrating an example of a viewing article according to the embodiment of the present invention.

FIG. 6 is a table illustrating an example of text analysis of the viewing article according to the embodiment of the present invention.

FIG. 7 is a table illustrating an example of each of advertisements acquired based on a keyword extracted from the viewing article and the profitability of the advertisement according to the embodiment of the present invention.

FIG. 8 is a table illustrating an example of selecting a recommended advertisement from among the acquired advertisements according to the embodiment of the present invention.

FIG. 9 is an example of a flowchart according to the embodiment of the present invention.

### DETAILED DESCRIPTION OF THE INVENTION

An embodiment of the present invention will be described in detail below.

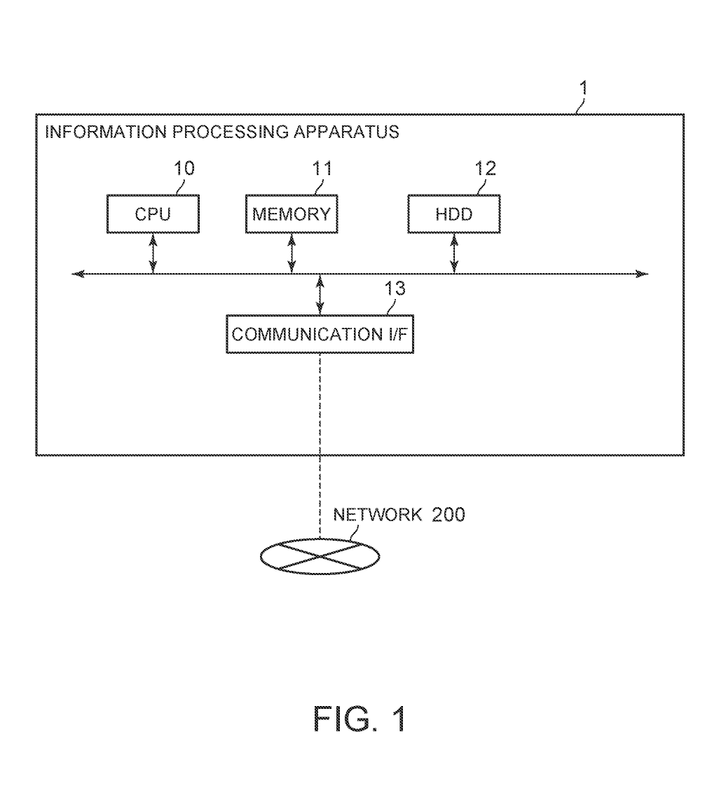

Referring first to FIG. 1, the hardware configuration of an information processing apparatus 1 of the embodiment will be described. Here, for example, the information processing apparatus is a host computer, a server, or the like, which originates a processing request to multiple computers through a network. Note that the configuration of the information processing apparatus 1 is not necessarily required to have the same configuration as that illustrated in FIG. 1, and it is only necessary to include hardware capable of implementing the embodiment. For example, the information processing apparatus 1 may additionally include input devices such as a mouse and a keyboard composed of input keys, a projector or a display device including a display using a panel such as liquid crystal or organic EL, an optical drive for reading and writing data stored on a CD or a DVD, and the like.

The information processing apparatus 1 includes a CPU 10 that executes a predetermined program to control the entire information processing apparatus 1, a memory 11 composed of a read-only nonvolatile memory, such as a mask ROM, an EPROM, or an SSD, which stores a program to be read by the CPU 10 when the information processing apparatus 1 is powered on, a working volatile memory, such as an SRAM or a DRAM, used by the CPU 10 to read the program and temporarily write data generated by arithmetic processing or the like, and an HDD 12 capable of holding various data records when the information processing apparatus 1 is powered off.

The information processing apparatus 1 further includes a communication I/F 13. The information processing apparatus 1 is connected to a network 200 through the communication I/F 13. The communication I/F 13 is to access various pieces of information accessible via the network 200 based on the operation of the CPU 10. Specific examples of the communication I/F 13 include a USB port, a LAN port, and a wireless LAN port, and any port may be used as long as the communication I/F 13 can exchange data with external devices.

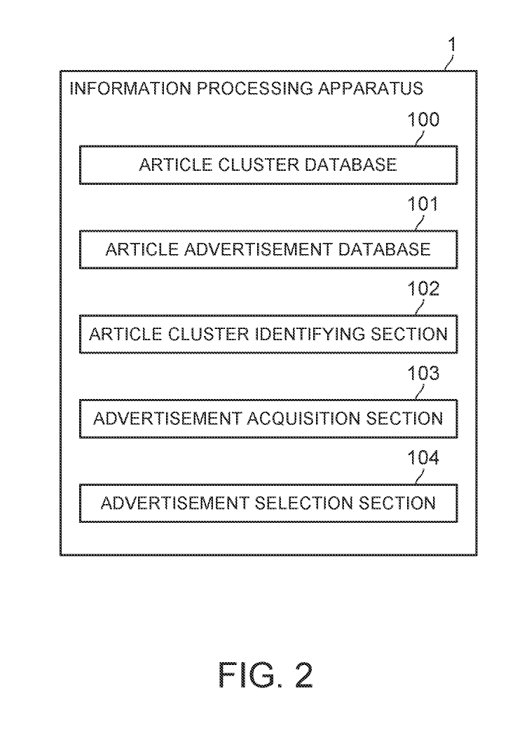

FIG. 2 is a functional block diagram of the information processing apparatus 1 according to the embodiment of the present invention. As illustrated in FIG. 2, the information processing apparatus 1 according to the present invention includes an article cluster database 100, an article advertisement database 101, an article cluster identifying section 102, an advertisement acquisition section 103, and an advertisement selection section 104.

The article cluster database 100 of the information processing apparatus 1 is configured to include word clusters, created by morphologically analyzing articles accessible via the network 200 and grouping words appearing in the articles based on the appearance frequencies of the words, and article clusters created by grouping articles similar in word appearance tendency. The article cluster database 100 may be configured to include only the article clusters created by grouping articles similar in word appearance tendency. The “articles” here mean a wide variety of information viewable by many and unspecified people. For example, the articles may include information acquired from sites to distribute social articles on politics and economics, and the like, information acquired from sites to distribute sports articles, and further information acquired from portal sites such as search engines to introduce information to users or information acquired from service providing sites such as EC sites. The details of the “word clusters” and “article clusters” mentioned above will be described later.

Thus, articles that cover a wide variety of categories are acquired and stored, for example, in the HDD 12 or the like. Further, a database of acquired articles is made and stored.

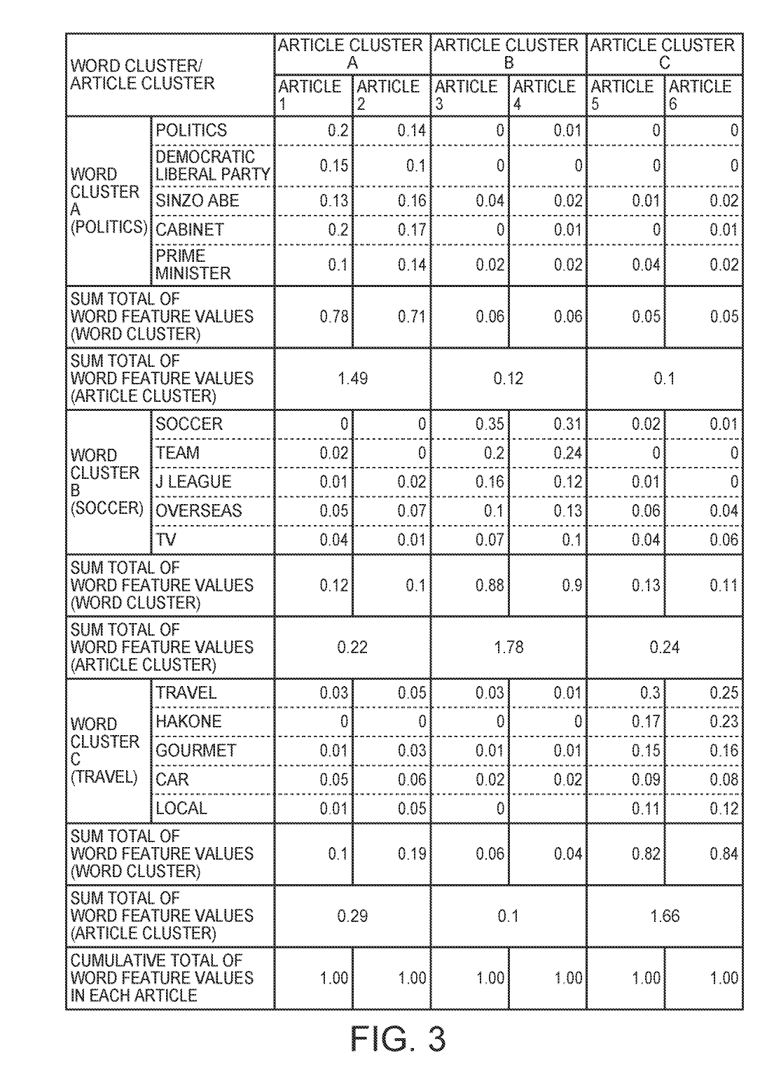

For example, as the method of making the database of acquired articles, there is a so-called clustering method, in which text that constitutes each of acquired articles is morphologically analyzed to decompose the text into words and extract the words, and articles similar in word appearance tendency and the words are grouped. Grouping of articles similar in word appearance tendency makes possible categorization according to the word features of the articles. An example of the article cluster database 100 in which articles and words are grouped by clustering is illustrated in FIG. 3. A value of 0.2 corresponding to the word “Politics” in Article 1 belonging to “Article Cluster A” represents the appearance rate of the word “Politics” in Article 1. Through the clustering, the appearance rate of each word is featured in each of article clusters “Article Cluster A,” “Article Cluster B,” and “Article Cluster C.” For example, in “Article Cluster A,” it is found that the appearance rates of words associated with politics such as “Politics” and “Democratic Liberal Party” are high. This is because political articles high in appearance rate of each word associated with politics are grouped. Similarly, in “Article Cluster B,” soccer-related articles high in appearance rate of each word associated with soccer such as “Soccer” and “Team” are grouped, and in “Article Cluster C,” travel-related articles high in appearance rate of each word associated with travel such as “Travel” and “Hakone” are grouped.

The same applies to the word clusters “Word Cluster A,” “Word Cluster B,” and “Word Cluster C.” For example, in “Word Cluster A,” words similar in appearance tendency in each of articles associated with politics such as “Politics” and “Democratic Liberal Party” are grouped. Similarly, in “Word Cluster B,” words similar in appearance tendency in each of articles associated with soccer such as “Soccer” and “Team” are grouped, and in “Word Cluster C,” words similar in appearance tendency in each of articles associated with travel such as “Travel” and “Hakone” are grouped. Thus, in the embodiment, a database having article clusters in the lateral direction and word clusters in the vertical direction is included as the article cluster database 100 in the embodiment.

In the conventional, for example, a two-dimensional database including lateral article clusters and vertical word clusters is generated by performing lateral clustering and vertical clustering alternately. By performing clustering in both directions alternately, a database in which each specific word intensively appears in a specific article cluster can be made.

Since the specific word intensively appears in the specific article cluster, a correspondence relationship between an article cluster and a word cluster to indicate which word cluster corresponds to which article cluster is made clear. In other words, in the case of a word appearing in a word cluster corresponding to a certain article cluster, the appearance rate of the word appearing in article clusters other than the corresponding article cluster is insignificant. Therefore, only the clustering of articles in the lateral direction without clustering words is enough to be applied to the present invention. Although the cluster hierarchy can be preset by a program or the like in the memory 11, it is preferred to divide the cluster hierarchy into as many clusters as possible. For example, a case where the article cluster to which soccer-related articles belong is “Soccer” is substantially different in meaning from a case where the article cluster is “J League.” Dividing the cluster hierarchy into as many clusters as possible makes clear the features of respective articles.

It is also preferred to refresh the article clustering every predetermined period. When a large number of new articles are acquired during the predetermined period, if the articles are clustered again, an article cluster to which a certain article belongs may change to another article cluster. For example, when “Entertainer X” appearing on TV made a sudden transition from a comedian to a soccer player, it is preferred that the entertainer X should change to belong to the article (or word) cluster “Sports” from the article (or word) cluster “Variety TV Program.” Thus, it is preferred to perform re-clustering so as to update the article cluster database 100 periodically according to information as fresh as possible. In the description of the embodiment, articles are clustered based on similarities in word appearance tendency, but any other method may be used as long as the articles are clustered according to the contents of the articles. The method of generating article clusters does not limit the embodiment of the present invention.

The article cluster database 100 of the information processing apparatus 1 is generated by the CPU 10 reading a collection of articles stored in a storage device such as the HDD 12 and making a database of the collection of articles based on a program in which a predetermined database scheme stored in the memory 11 is written.

The article advertisement database 101 of the information processing apparatus 1 stores each of the article clusters grouped in the article cluster database 100 in association with advertisement information composed of each of advertisements placed in articles in the past and the profitability of the advertisement. Here the term “advertisement” means a measure taken by an advertiser to have many and unspecified users recognize a commercial product, a service, or an idea (hereinafter collectively referred to as a commercial product). In the embodiment, the information processing apparatus 1 serves as an advertising medium to deliver the advertisement provided by the advertiser to many and unspecified users through the network 200. The advertisement can be acquired through the network 200 from a computer (not illustrated) administrated by an advertising agency or the like.

Here, the “profitability of the advertisement” means an index for measuring how much profit is made for an advertised commercial product in the advertisement provided to many and unspecified users through the network 200. From the standpoint of profitability, the profitability varies such as profitability based on the revenue calculated from the advertisement unit price defined for each commercial product to be advertised, profitability based on the revenue calculated from the number of times the advertisement was displayed on information terminals of users, or profitability calculated based on the number of purchase agreements with users who accessed the displayed advertisement and actually purchased the advertised commercial product.

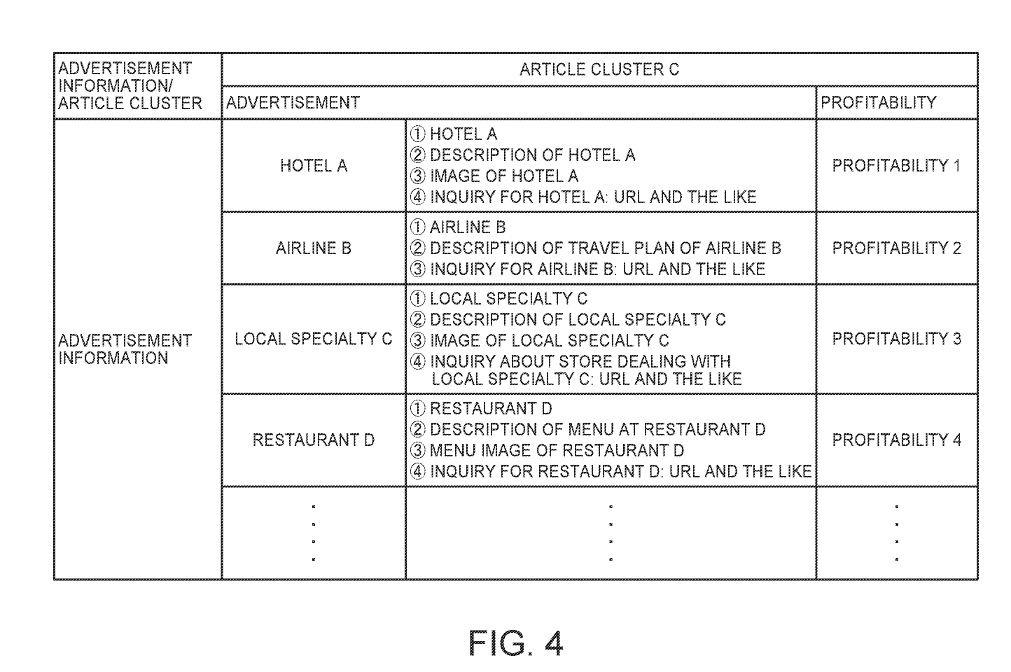

An example of associating advertisements placed in an article cluster grouped by clustering in the past with the profitability of each of the advertisements is illustrated in FIG. 4. FIG. 4 illustrates only “Article Cluster C” in the lateral direction for the sake of simplification. The advertisement information in the vertical direction includes advertisements placed in the past in articles belonging to “Article Cluster C” and the profitability of each advertisement. Here, it is preferred that information on advertisements associated with the article cluster should also include the name of an advertised commercial product and the description of the commercial product, information as text data such as an URL enabling access to the commercial product, and information for making the commercial product viewable to users such as images or video of the commercial product. The advertisement information can also include contact information (telephone number, address, e-mail address) to make inquiries about the commercial product, and these pieces of advertisement information can be combined arbitrarily. Further, the unit price to place the advertisement in each article, which is provided by the advertiser, may be recorded together in the advertisement information though such information is not to be advertised directly to users.

The article advertisement database 101 in FIG. 4 is configured to include the article cluster in the lateral direction and the advertisement information in the vertical direction. The article advertisement database 101 is generated in such a manner that, after the clustering to group articles based on the appearance tendency of each of words appearing in the articles like in FIG. 3, word information in the vertical direction is deleted and the advertisements placed in the past in the articles belonging to each article cluster are associated. For example, advertisements for “Hotel A,” “Airline B,” “Local Specialty C,” “Restaurant D,” and the like are stored in association with “Article Cluster C” as advertisements placed in the past in Article 5 and Article 6 belonging to “Article cluster C.” In the embodiment, it is assumed that information on words appearing in articles is deleted, but the advertisement information may be added to the article cluster database 100 in FIG. 3 without deleting the word information.

As mentioned above, various indexes can be used for the profitability of each advertisement, but in the embodiment, the index is defined as a conversion rate (CVR) indicating a ratio between the number of advertisement displays during a predetermined period and the number of user purchase agreements on each advertised commercial product. In such a definition of the profitability of the advertisement, it can be found what value of the advertised commercial product is received form users. Further, in consideration of the number of advertisement displays provided to many and unspecified users, a profit picture can be viewed in real time. Note that the profitability may also be defined as an amount of money obtained by multiplying this CVR by the sales amount of the advertised commercial product or by the unit price to place the advertisement obtained from the advertiser. For example, when purchase agreements with 100 users about a commercial product in an advertisement displayed 10,000 times to many and unspecified users are made, the CVR can be calculated at 1%, and when the unit selling price of this commercial product is ¥100,000, the profitability can be calculated as CVR× ¥100,000=¥1,000. Thus, the profitability may be defined based on the actual purchase records of users, or the profitability may be defined based on the number of advertisement displays or the unit price to place each advertisement defined for each commercial product.

In the embodiment, the profitability of each advertisement is defined by multiplying the above-mentioned CVR by the actual sales amount of each commercial product. The profitability of each advertisement thus defined is stored for each article cluster of the article advertisement database 101 in association with the advertisement. Like the article cluster database 100, it is preferred that the article advertisement database 101 should also be refreshed every predetermined period. Particularly, since the profitability of each advertisement is a parameter varying each time a user actually purchases an advertised commercial product, it is preferred to refresh the article advertisement database 101 at least at the same timing as that of refresh the article cluster database 100. Of course, the article advertisement database 101 may also refreshed in a span of time shorter than that of the article cluster database 100.

The article advertisement database 101 of the information processing apparatus 1 is generated by the CPU 10 reading a collection of articles stored in a storage device such as the HDD 12 to make a database of the collection of articles based on a program in which a predetermined database scheme stored in the memory 11 is written, and to associate each article group with the advertisement information.

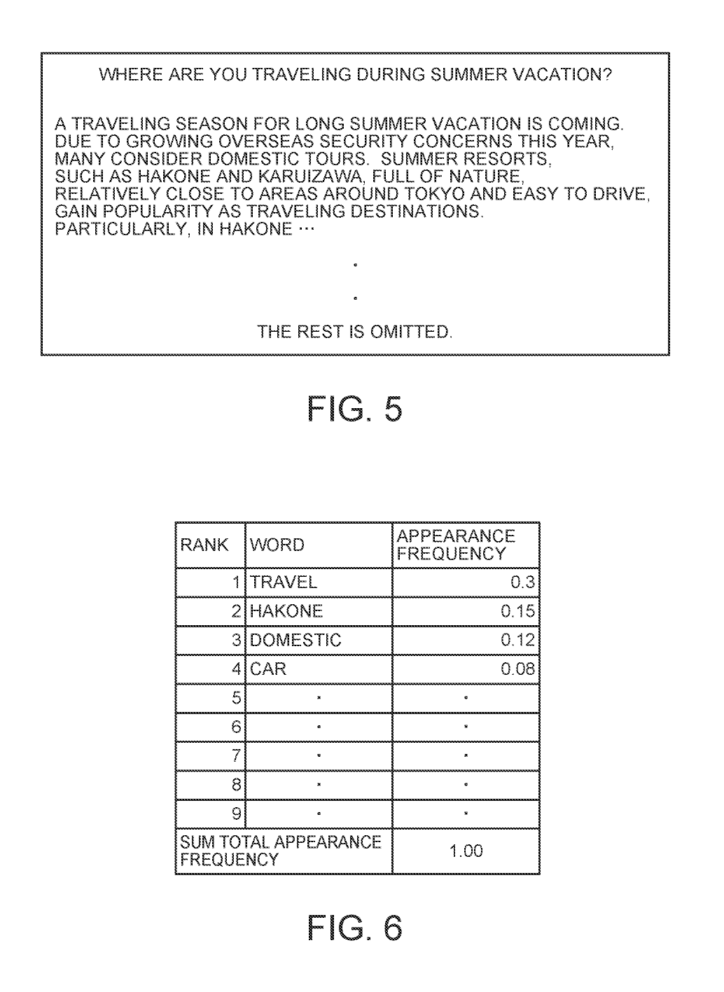

The article cluster identifying section 102 identifies an article cluster associated with a specified article based on words appearing in the specified article and words appearing in the article cluster database 100. An article as illustrated in FIG. 5 is an example of the “specified article” here. The specified article means text data acquired by a computer via the network 200 based on some operation intended by a user. As mentioned above, the acquisition sources of articles may include the sites to distribute social articles on politics and economics, and the like, the sites to distribute sports articles, and further the portal sites such as search engines to introduce information to users or the EC sites.

It is identified to which article cluster among the article clusters of the article cluster database 100 the acquired article as illustrated in FIG. 5 belongs. As the method of identifying an article cluster, there is a method of focusing on the degree of similarity calculated based on the appearance frequency of each word appearing in the specified article and the appearance frequency of the word belonging to each article cluster of the article cluster database 100. The appearance frequency of each word appearing in the specified article is as illustrated in FIG. 6. Each appearance frequency in FIG. 6 can be calculated by dividing the number of appearances of each word appearing in the article by the number of appearances of all words in the article. Thus, the degree of similarity of articles can be calculated by focusing on the appearance frequency of each word appearing in the articles.

As one of methods for calculating the degree of similarity of articles, there is a method using a degree of cosine similarity. Since the degree of cosine similarity is known as a method of calculating the degree of similarity between two comparison targets, the detailed description will be omitted. In the embodiment, the degree of similarity is calculated by focusing on a word vector based on the appearance frequency of each word appearing in each article belonging to an article cluster and a word vector based on the appearance frequency of the word appearing in the specified article. Based on the degree of similarity thus calculated, an article cluster associated with the specified article can be identified as “Article cluster C.” Note that the method of calculating the degree of similarity between articles is not limited to the degree of cosine similarity, and Euclidean distance may also be used, for example.

The article cluster identifying section 102 of the information processing apparatus 1 can be implemented by the CPU 10 reading the article cluster database 100 and the like stored in the HDD 12 based on a predetermined article cluster identifying program stored in the memory 11 to identify an article cluster.

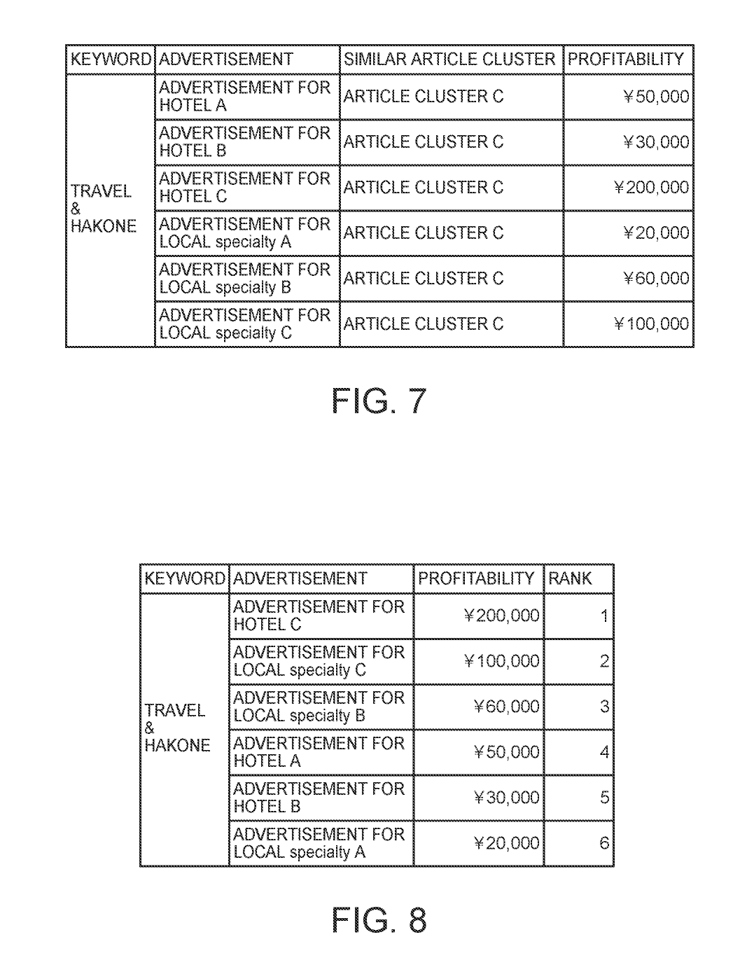

The advertisement acquisition section 103 of the information processing apparatus 1 selects a keyword from words included in the acquired article and appearing in the identified article cluster at high frequencies, compared with those in the other article clusters that are not identified, to acquire advertisements associated with the selected keyword via the network 200. The “keyword” here means a word(s) used to make a search on a computer or the like administrated by an advertising agency or the like to acquire advertisements. FIG. 7 is a table illustrating information related to advertisements acquired based on a keyword (“Travel & Hakone” here, and the keyword is referred to as “Travel & Hakone” below) selected from the “Article Cluster C” identified as described above. The “Travel & Hakone” here are higher in appearance frequency in articles belonging to “Article Cluster C” simply than “Article Cluster A” and “Article Cluster B” of the article cluster database 100, and high in appearance frequency in the specified article as well. For example, in addition to selecting a word(s) simply high in appearance frequency, a more featured word (i.e., a word high in appearance frequency in the article cluster database 100 but low in appearance frequency in the specified article) based on a correlation between the appearance frequencies in the specified article and the article cluster database 100 may be selected. Further, such a word that does not appear in the specified article but is extremely high in appearance frequency in the identified article cluster of the article cluster database 100 may be selected.

Suppose that the advertisement information acquired based on “Travel & Hakone” is as illustrated in FIG. 7. Here, it is preferred that each advertisement should include information as text data on the name of a commercial product to be advertised, the description of the commercial product, an URL and the like enabling access to the commercial product, and information for making the commercial product viewable to users such as an image(s) or video of the commercial product. Further, the unit price to place each advertisement in articles obtained from the advertiser, and the like may be acquired together as the advertisement information though it is not information to be directly advertised to users. As mentioned above, the profitability of each advertisement is defined as an amount of money obtained by multiplying the CVR by the sales amount of the advertised commercial product or by the unit price to place the advertisement obtained from the advertiser. Thus, the advertisement information is acquired based on the keyword “Travel & Hakone.”

The advertisement acquisition section 103 of the information processing apparatus 1 can be implemented by the CPU 10 reading the article cluster database 100 and the like stored based on a predetermined article cluster acquiring program stored in the memory 11 to select a keyword in order to acquire advertisement information from an advertising server or the like through the network 200 using the selected keyword.

Based on the advertisement information stored in the article advertisement database 101, the advertisement selection section 104 of the information processing apparatus 1 selects a recommended advertisement from advertisements acquired by the advertisement acquisition section 103. The acquired advertisements mean advertisement information as illustrated in FIG. 7. When the profitability of each advertisement is calculated as an amount of money, the acquired advertisement is ranked based on the profitability. Here, when an advertisement among acquired advertisements exists in the identified article cluster of the article advertisement database 101 in FIG. 4, it is preferred to use the profitability of the advertisement in the identified article cluster. On the other hand, when the advertisement among acquired advertisements does not appear in the identified article cluster of the article advertisement database 101 in FIG. 4, the unit price to place the advertisement defined for each commercial product or the like may also be used. FIG. 8 is a table illustrating a ranking list of the advertisement information acquired by the advertisement acquisition section 103 based on the profitability.

As a result of the ranking based on the profitability of the advertisement information, “Advertisement for Hotel C” and “Advertisement for Local Specialty C” get high in the ranking. Here, suppose that “Advertisement for Hotel C” is an advertisement that has never been placed in articles belonging to the identified article cluster C. Suppose further that “Advertisement for Local Specialty C” is an advertisement that has been placed in articles belonging to the identified article cluster C. In this case, since “Advertisement for Local Specialty C” is high in profitability because a large number of users make inquiries about the local specialty C when the advertisement was placed actually in articles in the past to purchase the local specialty C, it can be said that “Advertisement for Local Specialty C” is high in profitability and hence is best for a recommended advertisement. Further, since “Advertisement for Hotel C” is simply high in unit price to place the advertisement though it has never been placed in articles in the past, it could be suitable as a recommended advertisement. Therefore, it can be said that “Advertisement for Hotel C” is an advertisement given a chance to place the advertisement and required to measure the profitability in the article cluster C. On the other hand, “Advertisement for Hotel A” can be determined to be an advertisement not to be selected from the listing results of the article cluster C. In such a case, “Advertisement for Local Specialty C” is selected at a high rate, “Advertisement for Hotel C” is selected at a middle rate, and “Advertisement for Hotel A” is selected at a low rate. Since each advertisement in each article cluster and the profitability of the advertisement are thus managed, an advertisement expected to be high in click-through rate can be selected under probabilistic control. Further, an advertisement can be probabilistically selected, rather than an advertisement determinately selected to make the maximum profit. This can prevent the deterioration of profitability due to a change in profitability of each advertisement, and a check for a new advertisement for which no chance to display is given, and further a reduction in the price of an advertisement having the highest advertisement unit price to the secondly high advertisement unit price.

The recommended advertisement selected by the advertisement selection section 104 is stored in association with a predetermined article cluster of the article advertisement database 101. Further, as for the profitability of each advertisement that does not exist in the article advertisement database 101 in the past, it is preferred that when a user has purchased an advertised commercial product, the profitability index should be changed from the unit price to place the advertisement to the sales amount of the advertised commercial product.

The advertisement selection section 104 of the information processing apparatus 1 can be implemented by the CPU 10 reading the article advertisement database 101 and the like stored based on a predetermined advertisement selecting program stored in the memory 11 to select an advertisement.

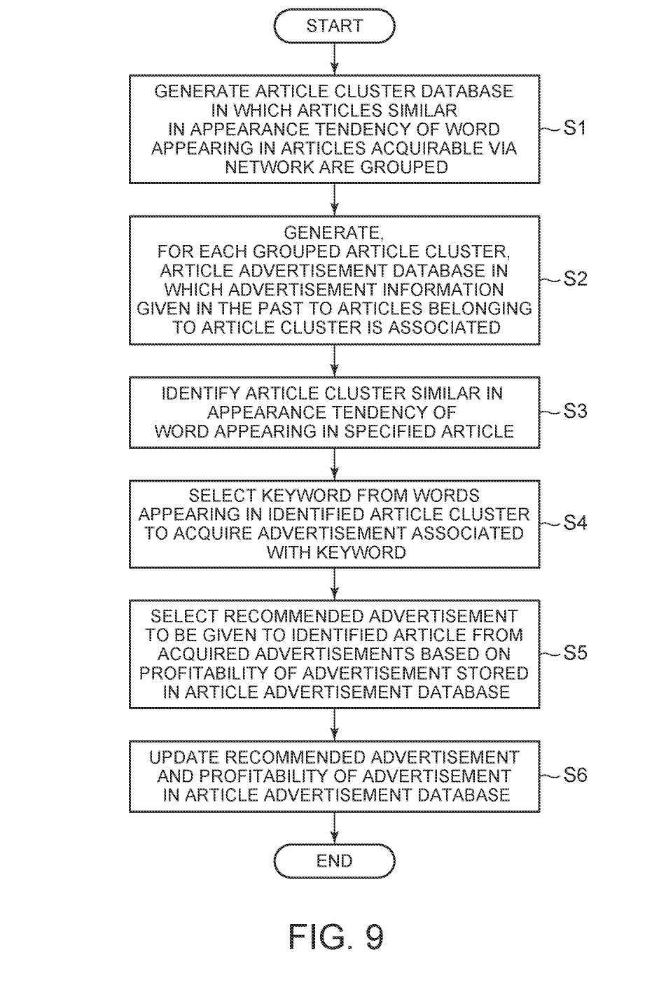

FIG. 9 is an example of a flowchart according to the embodiment of the present invention.

First, the article cluster database 100 in which articles similar in appearance tendency of each word appearing in each of the articles acquirable via the network 200 are grouped is generated (step 1). Then, the article advertisement database 101 in which advertisement information given in the past to articles belonging to each article cluster is associated with each grouped article cluster (step 2). Then, an article cluster similar in appearance tendency of each word appearing in a specified article is identified (step 3).

A keyword is selected from words appearing in the identified article cluster to acquire advertisements associated with the keyword (step 4). Then, a recommended advertisement to be placed in the specified article is selected based on the profitability of each of the acquired advertisements stored in the article advertisement database 101 (step 5). The recommended advertisement and the profitability of the advertisement are updated in the article advertisement database 101 (step 6).

As described above, in the embodiment, a recommended advertisement can be probabilistically selected based on the profitability of each advertisement placed in articles as an element other than the similarity to the specified article. As mentioned above, the probabilistic selection can be made under the control of a program based on the selection probability to define, as comprehensive determination indexes, profitability records of advertisements and the like based on the number of times to place each of the advertisements and the results of the advertisement placed when the advertisements have been placed in the past, or the unit price to place each of the advertisements and the like when the advertisements have never been placed in the past. For example, an example of defining the selection probability is as follows: When an advertisement is high in profitability and has been placed in the past, the advertisement is set to be selected at a rate of 70% of all advertisements, or when an advertisement is high in unit price to place the advertisement though it has never been placed in the past, the advertisement is set to be selected at a rate of 50% of all advertisements with an expectation of user click actions. However, the present invention is not limited to this example, any other setting is possible according to the number of times to place each of the advertisements, the profitability records of the advertisements, the unit price to place each of the advertisements, and the like. Further, the program may be so set that a threshold value will be defined for each of the determination indexes, such as the number of times to place each of the advertisements, the profitability records of the advertisements, the unit price to place each of the advertisements, and the like, to change the selection probability based on whether each index is larger or smaller than the predetermined threshold value.

Note that the contents equipped in an apparatus used and the number of apparatuses are not limited those in the embodiment as long as the configuration can carry out the present invention.

We claim:

1. An information processing apparatus comprising:
an article cluster database that stores an article cluster of articles;
an article cluster identifying section that identifies an article cluster associated with a specified article based on each word appearing in the specified article and each word appearing in the article cluster;
an article advertisement database that stores advertisement information, composed of each advertisement placed in the articles in the past and profitability information of an index for measuring how much profit is made from each advertisement, with each of the article clusters;
an advertisement acquisition section that selects a keyword about the specified article from the advertisements in the identified article cluster and the words appearing in the article to acquire advertisements associated with the selected keyword from a network; and
an advertisement selection section that selects a recommended advertisement from the advertisements acquired by the advertisement acquisition section based on profitability information for advertisements, stored in the article advertisement database, in the article cluster of the specified article identified by the article cluster identifying section such that a selection probability will be set high as the profitability of each of the advertisements is high.

2. The information processing apparatus according to claim 1, wherein each of the advertisements includes a name of a commercial product, description of the commercial product, an image of the commercial product, an URL enabling access to the commercial product, and a unit price to place the advertisement in each of the articles, or any combination thereof.

3. The information processing apparatus according to claim 1, wherein the profitability information includes a conversion rate (CVR), for each advertised commercial product, indicating a ratio between a number of advertisement displays during a predetermined period and a number of consumer purchase agreements.

4. The information processing apparatus according to claim 1, wherein, when there is an advertisement identical to a stored advertisement, in the identified article cluster, from among the acquired advertisements, the advertisement selection section selects a recommended advertisement from the acquired advertisements based on the advertisement information stored in the identified article cluster.

5. The information processing apparatus according to claim 1, wherein, when there is no advertisement identical to any advertisement stored in the identified article cluster, from among the acquired advertisements, the advertisement selection section selects a recommended advertisement from the acquired advertisements using a unit price, to place the recommended advertisement in each of the articles, as the profitability of each of the acquired advertisements.

6. An information processing method comprising:
generating an article cluster database that stores an article cluster of articles;
identifying the article cluster associated with a specified article based on each word appearing in the specified article and each word appearing in the article cluster;
generating an article advertisement database that stores advertisement information, composed of each of advertisements placed in the articles in the past and profitability information of an index for measuring how much profit is made from each advertisement, with each of the article clusters;
selecting a keyword about the specified article from the advertisements in the identified article cluster and the words appearing in the article to acquire advertisements associated with the selected keyword from a network; and
selecting a recommended advertisement from the acquired advertisements based on the profitability information on advertisements stored in the article advertisement database for the identified article cluster of the specified article in such a manner that a selection probability will be set high when the profitability of each of the advertisements is high.

7. A program causing a computer to execute:
generating an article cluster database that stores an article cluster of articles;
identifying the article cluster associated with a specified article based on each word appearing in the specified article and each word appearing in the article cluster;
generating an article advertisement database that stores advertisement information, composed of each advertisement placed in the articles in the past and profitability information of an index for measuring how much profit is made from each advertisement, with each of the article clusters;
selecting a keyword about the specified article from the advertisements in the identified article cluster and the words appearing in the article to acquire advertisements associated with the selected keyword from a network; and
selecting a recommended advertisement from the acquired advertisements based on the profitability information on advertisements stored in the article advertisement database for the identified article cluster of the specified article in such a manner that a selection probability will be set high when the profitability of each of the advertisements is high.
